(19) United States
(12) Patent Application Publication
(10) Pub. No.: US 2014/0309036 A1
(43) Pub. Date: Oct. 16, 2014

(54) Set of body motions and methods to control game play using a laser gun in Computer Games.

(71) Applicant: Robin Hossain, Atlanta, GA (US)

(72) Inventor: Robin Hossain, Atlanta, GA (US)

(73) Assignee: Robin Arfan Hossain, Atlanta, GA (US)

(21) Appl. No.: 13/860,920

(22) Filed: Apr. 11, 2013

(51) Int. Cl. A63F 13/20

(52) U.S. Cl. CPC A63F 13/06
USPC 463/36

(57) ABSTRACT

This method allows players to immerse themselves in a virtual world and shoot targets directly while moving around and controlling the game play. The players motion is tracked as replicated directly inside the game within a certain physical gaming zone. Laser guns are also tracked and translated into the game for motion and targeting.

### CROSS REFERENCE

Not applicable

### STATEMENT REGARDING FEDERALLY SPONSORED RESEARCH OR DEVELOPMENT

This is a private effort with no federal links.

### NAMES OF THE PARTIES TO A JOINT RESEARCH AGREEMENT

This research is the sole effort of the applicant and inventor Mr. Robin Arfan Hossain.

### REFERENCE TO A SEQUENCE LISTING

Not applicable

### BACKGROUND OF THE INVENTION

This invention came about as a result of development into police marksman training software. The system was tested in gaming environments using off the shelf games and then adapted and tweaked to suit front person shooter games.

### BRIEF SUMMARY OF THE INVENTION

This invention is a gaming system that allows the player to use a gun or rifle that uses a laser pointer on the gaming screen to track where the gun is pointing via a camera looking at the screen.

As the gun moves, the laser position on the screen moves and the reaction of the game occurs in a similar fashion to using a mouse.

Additionally a player can move around to aid motion involvement in the game.

This gaming system can also be used to improve situational awareness reflexes.

### BRIEF DESCRIPTION OF THE DRAWINGS

The drawings depict views of how a player stands and moves when playing a game.

FIG. 1. Shows a bird's eye view of the player with respect to a screen and seating and sensors.

FIG. 2. Shows a side view of a player, seating, the screen and sensors.

FIG. 3. Shows a bird's eye view of a player in two different positions.

FIG. 4. Shows how the in-game cross hairs follow the laser dot on the screen in free firing mode after the trigger is pressed.

FIG. 5. Depicts another free firing mode where the cross hairs follow the laser dot when the trigger is pressed, but then return the screen view and cross hair back to the original position after firing a shot.

FIG. 6. allows the entire gaming viewpoint to be moved by pointing the laser to any edge of the screen and thus causing the viewpoint to move in that direction until the laser is brought back to the middle of the screen.

The drawings also show how the player moves the laser around the screen and how the gaming system could react to that motion.

This description contains no new materials.

### DESCRIPTION

The present invention relates to a set of body motions and methods to control game play using a laser gun in Computer Games.

The device is comprised of the following elements:

The invention is broken down into various parts as follows:

The player can move left, right, forward and backward from a central reference point.

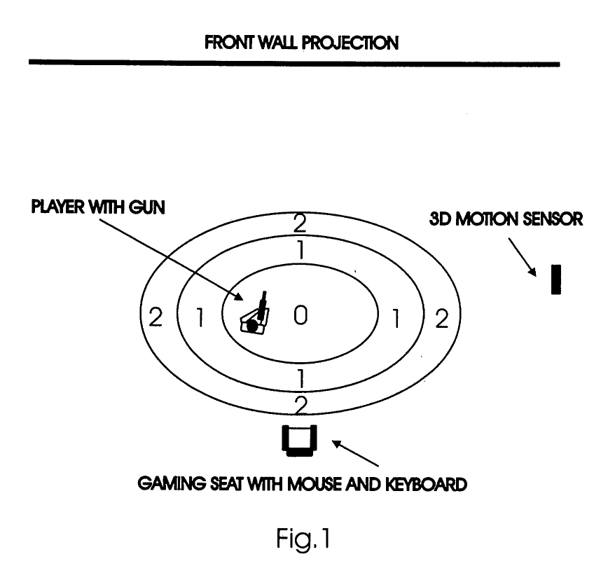

FIG. 1 shows the position of a player and spatial zones around a central point.

Movements that take place within a given physical boundary (such as a circumference of 5 ft) are directly mapped into the game movement. Movement into an area directly outside of the given circumference results in continuous motion in the chosen direction. Leaning outside the central zone will also result in continuous motion in the chosen direction.

Again, FIG. 1 shows zones—numbered 0,1 and 2 where movement into these zones cause different actions within a game. In particular zone 0 causes a direct mapping of the players motion in a game, whereas zone 1 causes the player to continuously move in the chosen direction and zone 2 increases the speed of motion in the chosen direction.

The player can also jump and crouch and those actions are simultaneously applied. The player can take control of a vehicle or turret weapon at any time by jumping or pressing a button on the laser weapon.

The player's location is determined via infra red markers on the players body, or via magnetic sensors, or via video analysis or via positional sensors such as a Microsoft kinect.

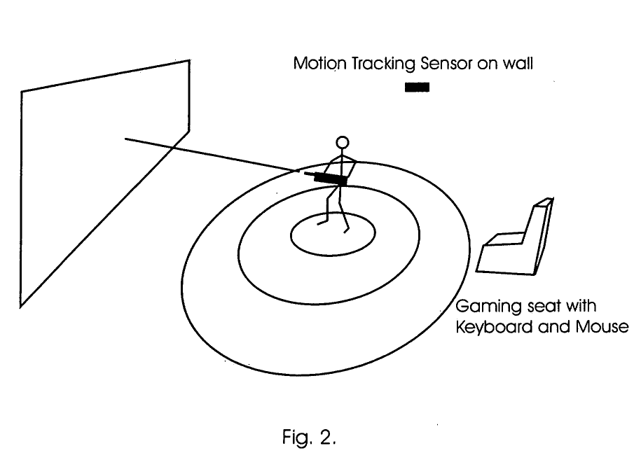

FIG. 2. depicts a side view of the player pointing a weapon laser onto the projection wall.

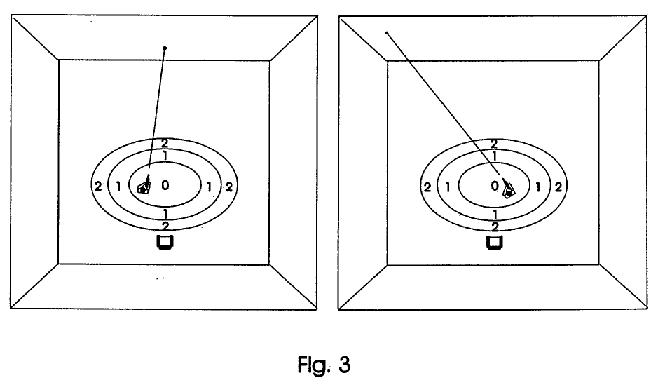

FIG. 3. depicts a birds eye view of a player at different positions while playing.

Vehicle motion is controlled by keyboard and mouse where the player can quickly sit down during those parts of the game—or—the player can continue to use his body motion and laser gun to control vehicle motion.

The player uses a laser weapon to control where they are looking in a game as well as where they are firing in a game. The laser on the weaponry may be a variety of wavelengths or colors to enable differentiation between different players including wavelengths invisible to the naked eye such as infra red.

The position of the laser on the gaming screen or wall controls the direction and speed at which the player turns their view in the game. There are various modes of control which the player can select from buttons on the weapon. All modes of control define an area around the center of the screen where there is no change of view—only simply targeting of spots to shoot. As the laser moves out of the central zone, the view of the player will also change. The speed of viewpoint change and the size of the central shoot only zone can preset and selected on the fly by the player via buttons on the weapon.

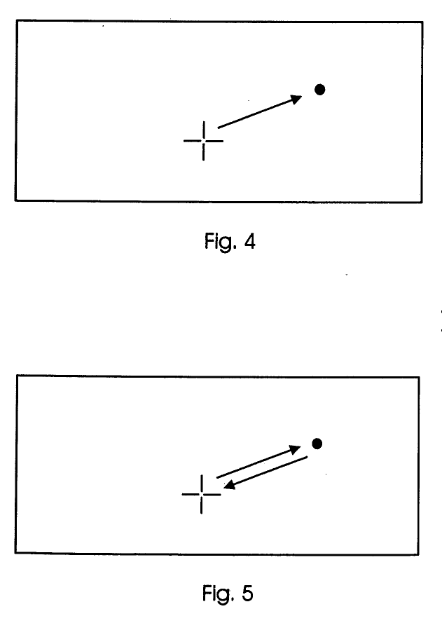

FIG. 4 depicts an example of motion where the screen view moves to follow the laser dot. If the dot is centered the screen view stops moving. The speed of screen movement may be linked to the distance of the laser dot from the gaming reticule. So the further away the dot is, the faster the screen view moves to catch up.

FIG. 5 shows example where screen view moves to follow the laser dot very quickly and possibly instantaneously only when the player fires a shot, then returns the screen view to the previous position thus allowing the player to point and shoot anywhere on the screen while keeping his screen view virtually the same.

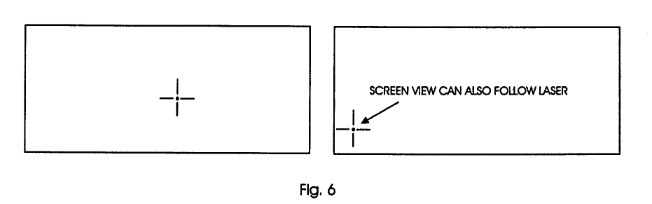

In FIG. 6. the in game reticule or the weapon targeting position follows the laser and in FIG. 7. where the laser gets close to the edge of the screen, the entire screen view will shift and move in the direction of the laser to allow the player to view all around in any direction in this manner.

The game play is controlled via two principle methods. The first method is by simulating mouse movement/clicks and keyboard and the second is via a game's Software Development kit.

Multiple players can play as one player with a team lead controlling the games motion as well as firing. Additional players do not control motion but can fire anywhere on the screen.

Players laser positions are tracked via one or more web cameras. Different players use different colored lasers.

The web cameras will have bandwidth filters to enable easier differentiation of different laser colors.

In a windows environment, laser tracking will occur as a device driver at kernel layer to avoid latency issues as found in the Sony Move and the Xbox Kinect.

Necessary elements are the body tracking and the laser tracking on a gun that also has a trigger to fire and button to change weapon type and other options in any given game. Optional elements are multiple screens, multiple web cameras and multiple motion tracking cameras.

Relationship between elements:

The weaponry

The players hold the laser guns in hand. The guns can be wireless or wired and may or may not have recoil and inbuilt sound enabled.

If playing in a multi-player unit that simulates a single player—the main player would typically stand in the middle while the support players would flank him on either side.

The typical gaming environment is a single widescreen 200″+3D rear projection. This can also be front projection and multiple screens—front, left, right, above and below.

The player is tracked via either LED tracking on their body or via projected infra red lighting in three dimensions allowing determination of where the players head and body is in 3D space.

Tracking the players head and body position allows the system to determine where they are with respect to the gaming motion control zones as well as whether the player is standing, crouching, jumping or leaning.

These positions and motions in turn translate to simulated key presses to control the game.

Simultaneously, the laser is tracked on the gaming wall where the 3D (or 2D) gaming image is projected. The laser position controls where to shoot and which way to turn the players view. Multiple walls can also be used—that is front, left and right as well as above and below and behind.

Spherical walls can also be used to provide seamless views.

The gaming computer as well as additional computers that process the motion and then feed them to the gaming computer.

The invention can be used in police training and marksman training as well as SWAT and military training.

Other gaming systems do not use laser tracking and are inaccurate in where the guns are pointing as well as where the player has to be. They also do not combine this with body motion tracking in the same manner.

Current systems do not combine body tracking with laser tracking. Current systems do not precisely define continuous lateral movement of a player simulated from a limited playing area. Current systems do not provide an additional layer on top of an off the shelf game to allow them to be played in this alternate manner with zero modification to the original game.

1. What is claimed is a set of body motions and methods to control game play using a laser gun in computer games.
